(19) United States
(12) Patent Application Publication
(10) Pub. No.: US 2012/0168198 A1
(43) Pub. Date: Jul. 5, 2012

(54) METHOD FOR PRODUCING COMPONENTS FOR ELECTRICAL CONTACTS, AND COMPONENTS THEMSELVES

(75) Inventor: Dietmar GENTSCH, Ratingen (DE)

(73) Assignee: ABB Technology AG, Zurich (CH)

(21) Appl. No.: 13/226,144

(22) Filed: Sep. 6, 2011

Related U.S. Application Data
(63) Continuation of application No. PCT/EP2010/001086, filed on Feb. 22, 2010.

(30) Foreign Application Priority Data
Mar. 6, 2009 (DE) 102009012145.5

(51) Int. Cl. H01B 3/10; B05D 5/12; C25D 5/48; B05D 3/10; C23C 28/02; H01B 7/00; B05D 3/12

(52) U.S. Cl. 174/110 A; 174/110 R; 427/123; 427/125; 205/184; 205/221

(57) ABSTRACT

A method for producing electrical components for electrical contacts, and such a component are provided. To achieve simpler production of a partial surface treatment, which likewise exhibits optimal current carrying capacity, with minimum material use of noble metals, the entirety of the components are provided with an electrically insulating passivation layer, and the passivation is then removed chemically or mechanically at the contact points of the components. The entire components are put into an electrolytic bath, and a noble metal is deposited only on the parts of the components from which the passivation layer has been removed.

### RELATED APPLICATION

This application claims priority as a continuation application under 35 U.S.C. §120 to PCT/EP 2010/001086, which was filed as an International Application on Feb. 22, 2010 designating the U.S., and which claims priority to German Application 10 2009 012 145.5, which was filed in Germany on Mar. 6, 2009. The entire contents of these applications are hereby incorporated by reference in their entireties.

### FIELD

The present disclosure relates to a method for producing components for electrical contacts and/or electrical connecting elements, and to an electrical component of an electrical switchgear assembly on which contact surfaces are located for making contact with other components.

### BACKGROUND INFORMATION

For electrical components such as switches, contacts of switches and electrical connectors, it is desirable for the contact resistances in the contact area to be as good as possible, that is to say to have as low of a resistance as possible. For this purpose, it is known for contact points to be silver-plated or gold-plated. These are expensive noble metals. The electrically conductive body itself is, in contrast, composed apart from this of an electrically highly conductive material such as aluminum, and only the contact points are in this case covered with expensive noble metals such as gold or silver.

However, the production of contacts such as these, which are generally vapor-deposited, is also technically complex and difficult. It is therefore technically complex and difficult to produce a constant quality for such partial noble-metal coatings.

Components and contact components such as these in medium-voltage and possibly high-voltage switchgear assemblies are subject to very particular requirements. In this case, large-volume components are necessary, and are generally composed of aluminum. Their partial silver plating or gold plating which is provided in the electrical contact area or contact-making area must be made solid and, particularly because of the high voltage levels, must allow extremely low resistances, while at the same time allowing a high current-carrying capability in the contact area of the contact points, which are generally screwed.

### SUMMARY

An exemplary embodiment of the present disclosure provides a method for producing a component for at least one electrical contact. The at least one electrical contact has a partial noble-network coating in an area of contact surfaces of the component. The exemplary method includes applying an electrically insulating passivation layer over the entirety of the component, removing the passivation layer at contact points of the component, passing the entire component through an electrolytic bath, and depositing a noble metal only on the contact points of the component from which the passivation layer has been removed.

An exemplary embodiment of the present disclosure provides a component of an electrical switchgear assembly. The exemplary component includes at least one contact surface area configured to make contact with another component, and a non-contact surface area which is configured to be free from contact with the other component. Only the at least one contact surface area which is configured to make contact with the other component is coated with a noble metal, and the non-contact surface area which is configured to be free from contact with the other component has an electrically insulating passivation layer applied thereon.

### BRIEF DESCRIPTION OF THE DRAWINGS

Additional refinements, advantages and features of the present disclosure are described in more detail below with reference to exemplary embodiments illustrated in the drawings, in which:

FIG. 1 shows a pole part of a medium-voltage switchgear assembly according to an exemplary embodiment of the present disclosure; and

FIG. 2 shows a detailed view of a component, which is coated according to an exemplary embodiment of the present disclosure, of a pole part.

### DETAILED DESCRIPTION

Exemplary embodiments of the present disclosure provide a method for producing components for electrical contacts as well as the component itself in which a partial surface treatment can be produced more easily with minimal material use of noble metals, likewise with an optimum current-carrying capability.

In accordance with an exemplary embodiment, a method is provided for producing components for electrical contacts and/or electrical connecting elements, which are provided with a partial noble-network coating in the area of the contact surfaces.

In accordance with an exemplary embodiment, a component of an electrical switchgear assembly is provided, on which contact surfaces are located for making contact with other components.

In accordance with exemplary embodiments of the method and component(s), the component(s) is/are first of all provided overall with an electrical/electrically insulating passivation layer or are provided with a chemical substance, and the passivation is then chemically or mechanically removed at the contact points. The entire component is then passed to an electrolytic bath, in which the noble metal is deposited only on those parts of the component from which the passivation has been removed.

In this way, only as much noble metal as is required is applied.

Concentration of the deposition at the deposition point furthermore allows the process to be reproduced to a very great extent by means of the parameters which can be set by electrolysis. In addition, because of the electrically passivated surface of the component, no noble metal is deposited anywhere else on the component during the electrolysis.

This technique considerably simplifies the method while at the same time allowing good reproducibility.

In accordance with an exemplary embodiment, the component can be composed of aluminum, and the passivation layer can be composed of an aluminum-oxide layer which is produced electrolytically and is referred to as anodization. In the case of chemical deposition, the so-called sol-gel process can be used. This choice of material allows a passivation layer to be produced in a simple manner. Aluminum is, in this case, a non-noble metal, but has relatively high electrical conductivity. In contrast, corrosive processes with other materials can take place at electrical contact surfaces. In order to avoid this at the contact surfaces and to ensure an electrical contact resistance which is as low as possible and is low in a stable form over time, these contact surfaces, and only these contact surfaces, are coated with a noble metal such as gold or silver.

In accordance with an exemplary embodiment, the components which are composed of aluminum are anodized directly after production by heat pressing, forging or as an aluminum casting. The manufacturing steps subsequent to the anodization process or the sol-gel process are simpler and cheaper.

The passivation layer or the chemically applied layer can have a layer thickness of up to 100 micrometers, for example.

In accordance with an exemplary embodiment, the components are components of a low-voltage, medium-voltage or high-voltage switchgear assembly, in which components the passivation layer is removed only from those areas which form the contact surfaces with other components and the noble-metal coating is deposited there.

With respect to a component of an electrical switchgear assembly on which contact surfaces are located for making contacts with other components, only those surface areas which are used as contact surfaces are coated with a noble metal, and the rest of the surface is provided with an electrically insulating passivation layer. When using aluminum as the component material, the component has a high current-carrying capability using a comparatively low-cost material, while only the contact areas, which are electrically highly loaded, are coated with a noble metal.

In accordance with an exemplary embodiment, the layer thickness of the passivation layer is between 0.05 and 100 micrometers, for example.

In accordance with an exemplary embodiment, the noble metal which is deposited as a coating can be silver or gold, for example. Since the noble metal is deposited reproducibly only on the actually required areas in accordance with exemplary embodiments of the present disclosure, considerable amounts of the noble metal are saved in comparison to known methods. With the material-removing exposure of the areas to be coated with the noble metal, or with them being chemically etched free, these areas, which are then once again not passivated, can be manufactured very precisely.

In addition, the process of applying the noble metal by electrolytic deposition is simple, because the entire component can be placed into the electrolysis bath. A noble metal is automatically deposited only where the exposed surfaces of the passivation layer are present. Therefore, the noble metal is automatically deposited only there, even though the entire component is in the electrolysis bath.

In accordance with an exemplary embodiment, the passivation layer can be composed of an oxide of the material of the component. For example, the component can be composed of aluminum, and the passivation layer can be composed with the oxide, that is to say the passivation layer is composed of aluminum oxide.

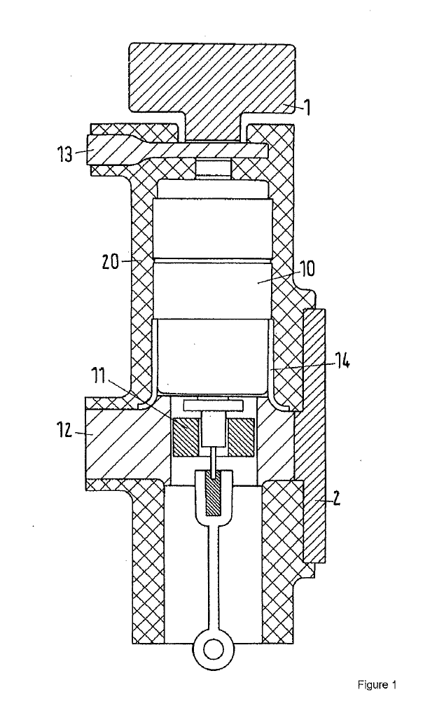

FIG. 1 shows a cross section through a so-called pole part of a medium-voltage switchgear assembly within which a vacuum switching chamber 10 is arranged. The connections thereof are passed to the exterior via the connecting parts 12 and 13. In accordance with an exemplary embodiment of the present disclosure, these connecting parts 12 and 13 are provided with the area silver-plating according to the disclosure.

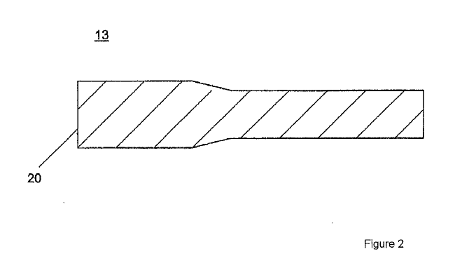

FIG. 2 shows the upper connecting piece 13 in detail. Since it is important here to achieve a high current-carrying capability, these parts are composed of highly conductive material, such as aluminum, for example. However, in order to achieve a contact resistance which is as low as possible on the outer connecting surface, precisely these areas, and only these areas, are coated with noble metals in the manner according to the present disclosure.

In order to prevent an unnecessarily large amount of noble metal from being wasted, for example, by the entire component 12 being coated with noble metal in the known manner, the aluminum component is first of all passivated, for example anodized, and subsequently only the required connecting surface 20 is coated with noble metal. This minimizes the consumption of noble metal just to the required areas. For this purpose, before the coating process, the passivation is removed again only in the required area of the connecting surface 20, as a result of which the noble metal is deposited only there during the noble-metal coating process.

In addition to the component described here, the present disclosure is applicable to the following components of a low-voltage, medium-voltage or high-voltage switchgear assembly:

all the connecting parts in the pole housing of a switchgear assembly whose volume is composed of aluminum and which have only a connecting part surface where contact is made with other current-carrying parts,
electrical and mechanical bushings on a pole part of a switchgear assembly, and
busbars of a medium-voltage switchgear assembly.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method for producing a component for at least one electrical contact, the at least one electrical contact having a partial noble-network coating in an area of contact surfaces of the component, the method comprising:
applying an electrically insulating passivation layer over the entirety of the component;
removing the passivation layer at contact points of the component;
passing the entire component through an electrolytic bath; and
depositing a noble metal only on the contact points of the component from which the passivation layer has been removed.

2. The method as claimed in claim 1, wherein the component is composed of aluminum, and the passivation layer is composed of an aluminum-oxide layer.

3. The method as claimed in claim 2, wherein the component which is composed of aluminum is anodized directly after production by at least one of heat pressing, forging, and an aluminum casting.

4. The method as claimed in claim 1, wherein the passivation layer is applied with a layer thickness of up to 100 micrometers.

5. The method as claimed in claim 1, wherein the component is a component of at least one of a low-voltage, medium-voltage and high-voltage switchgear assembly, and the passivation layer is removed only from those areas which form contact surfaces with other components and the noble-metal coating is deposited at the areas which form the contact surfaces.

6. The method as claimed in claim 1, wherein the electrical contacts include electrical connecting elements.

7. The method as claimed in claim 1, wherein passivation layer is applied by one of chemical coating using a sol-gel process, and plastic coating.

8. The method as claimed in claim 1, wherein the passivation layer is removed from the contact points at least one of mechanically and chemically.

9. The method as claimed in claim 2, wherein the aluminum-oxide layer of the passivation layer comprises an anodization which is produced electrolytically.

10. The method as claimed in claim 9, wherein the passivation layer is applied with a layer thickness of up to 100 micrometers.

11. The method as claimed in claim 3, wherein the passivation layer is applied with a layer thickness of up to 100 micrometers.

12. The method as claimed in claim 9, wherein the component is a component of at least one of a low-voltage, medium-voltage and high-voltage switchgear assembly, and the passivation layer is removed only from those areas which form contact surfaces with other components and the noble-metal coating is deposited at the areas which form the contact surfaces.

13. The method as claimed in claim 1, wherein the noble metal which is deposited is one of silver and gold.

14. A component of an electrical switchgear assembly, the component comprising:
at least one contact surface area configured to make contact with another component; and
a non-contact surface area which is configured to be free from contact with the other component; wherein only the at least one contact surface area which is configured to make contact with the other component is coated with a noble metal, and the non-contact surface area which is configured to be free from contact with the other component has an electrically insulating passivation layer applied thereon.

15. The component as claimed in claim 14, wherein the passivation layer has a thickness between 0.05 and 100 micrometers.

16. The component as claimed in claim 14, wherein the noble metal is deposited as a coating, and the noble metal is one of silver and gold.

17. The component as claimed in claim 14, wherein the passivation layer is composed of an oxide of a material of the component.

18. The component as claimed in claim 17, wherein the component is composed of aluminum, and the oxide is aluminum oxide.

19. The component as claimed in claim 14, wherein the passivation layer of the component is chemically coated using a sol-gel process.

20. The component as claimed in claim 14, wherein the component is chemically coated with a lacquer.

21. The component as claimed in claim 14, wherein the component is previously powder-coated in a hot state and is then subsequently coated.
